(19) United States
(12) Patent Application Publication
(10) Pub. No.: US 2007/0295834 A1
(43) Pub. Date: Dec. 27, 2007

(54) Sprayer for application of textured finish to surfaces

(76) Inventor: Eran Zagorsky, Northridge, CA (US)

Correspondence Address: Elliott N. Kramsky, Esq., Suite 400, 5850 Canoga Avenue, Woodland Hills, CA, 91367, US

(21) Appl. No.: 11/450,812

(22) Filed: Jun. 12, 2006

(51) Int. Cl. A01G 25/09

(52) U.S. Cl. 239/146; 239/288; 239/290

(57) ABSTRACT

A sprayer for providing a regulated flow of material to a gun wherein said material is disbursed by means of a flow of air provided by a compressor. The sprayer includes a number of features that facilitate usage. Such features include a polygonal-shaped free end of a cartridge shaft that is aligned with and coupled to thereby rotate with the augur of a pump. An aperture in a guard that overlies the free end of the shaft permits easy access with a socket-like tool for unfreezing the pump without disassembly. The rear panel of a hopper exceeds that of the side and front panels to permit tipping of the sprayer frame for manual transport without spillage of material. A hook is provided on the frame of the sprayer for ready attachment and detachment of controller electronics.

### BACKGROUND

1. Field of the Invention

The present invention relates to sprayers for use in the application of textured finishes to surfaces. More particularly, this invention pertains to a convenient and user-friendly sprayer unit for jobs of relatively-limited scope.

2. Description of the Prior Art

Texture spray equipment for use in small and medium size jobs that offers quick set-up, easy disassembly, compactness, portability and interchangeability of parts for quick, inexpensive repair has been developed over the years to address the inadequacies of bulky drywall material spraying systems for pumping liquids at job locations. Such bulky systems require mounting onto vehicles or trailers for ease of transportation and are characterized by, for example, large storage tanks that render their usage economical only for large jobs.

Examples of such spray equipment for smaller jobs include the sprayer taught by U.S. Pat. No. 5,967,426 of McLoed covering “Knockdown portable Liquid Drywall Material Spray System and Apparatus” and others. Such systems are typically mounted on a wheelable cart-like frame and interact with a compressor to provide a controllable spray of material for adhering onto a surface.

FIG. 1 is a schematic view of a generalized texture deposition system 10 of the type discussed above. The sprayer 11 of the sprayer system is indicated in broken outline. A hopper 12 is arranged to receive input material 14 for eventual deposition onto a surface. The material (e.g. drywall) 14 is transferred, generally by means of gravity feed, into a pump 16 of the screw-feed (rotor and stator) type. The pump 16 advances the received material 14 linearly toward a nozzle 18, in response to the output of an electric motor 20 whose speed and power are selectively controlled by means of a control box 22.

A hose 24 is fitted to the nozzle 18 to receive the material 14 at a predetermined flow rate. The material hose 24 feeds the flowing material to a gun 26. A second input to the gun 26 comprises an air flow generated by a compressor 28 and delivered through an air hose 30. The relative flow parameters of material 14 through the material hose 24 and air through the air hose 30 to the gun 26 determine the thickness and texture of the resultant material deposited upon a surface.

While texture deposition systems as described above may be configured for suitability for small and medium sized jobs, such equipment is often not user friendly. Although relatively portable, operation of such wheeled equipment is complicated by such limitations as spillage of material from the hopper 12 and shorting of the circuitry of the control box 22 as a result of weather. Furthermore, the sprayer 11 often requires disassembly of the pump 16 after period of extended non-use as a result of adhesion of the internal rotor to a surrounding layer of rubber within the stator.

### SUMMARY OF THE INVENTION

The present invention addresses the preceding and other shortcomings of the prior art by providing, in a first aspect, a sprayer for providing a regulated flow of material to a gun for subsequent dispersion onto a surface. Such sprayer includes a hopper for receiving the material.

A pump is provided having an elongated cartridge shaft and an elongated augur aligned with the shaft and arranged to respond to rotation of the shaft. The cartridge shaft has opposed coupled and free ends, the free end being of polygonal shape. The pump is responsive to a motor. A controller unit is provided for controlling the motor.

The sprayer includes a manually transportable frame.

In a second aspect, the invention provides a sprayer for providing a regulated flow of material to a gun for subsequent dispersion onto a surface that includes a hopper for receiving the material. Such hopper includes (i) a bottom characterized by a plurality panels oriented to slope downwardly toward an internal aperture, (ii) substantially parallel side panels, a rear panel and a front panel extending upwardly from edges of the bottom to define a predetermined volume, (iii) the height of the rear panel exceeding that of the front panel and (iv) the heights of each of the side panels being equal to that of the rear panel at their junctions with said rear panel and being equal to that of said front panel at their junctions with the front panel.

The sprayer in accordance with the second aspect of the invention additionally including a pump having an upstanding input port for receiving material from the hopper. Such pump being responsive to a motor. A controller unit for controlling the motor and a manually transportable frame.

In a third aspect, the invention provides a sprayer for providing a regulated flow of material to a gun for subsequent dispersion onto a surface. Such sprayer includes a hopper for receiving the material, a pump having an upstanding input port for receiving material from the hopper and responsive to a motor.

A controller unit is provided for controlling the motor. The sprayer includes a manually transportable frame that includes at least one horizontal rear frame member. A generally u-shaped member is fixed to the horizontal rear frame member. The controller has a hook for engaging the u-shaped member.

The foregoing and other features of the invention will become further apparent from the detailed description below. Such description is accompanied by a set of drawing figures. Numerals of the drawing figures, corresponding to those of the written description, point to the features of the invention with like numerals referring to like features throughout.

### BRIEF DESCRIPTION OFT THE DRAWINGS

FIG. 1 is a schematic view of a sprayer system in accordance with the prior art;

FIGS. 2(a) through 2(c) are a perspective view, a partially exploded side elevation view and an exploded perspective view of the cover assembly, respectively, of a sprayer in accordance with an embodiment of the invention;

FIGS. 3(a) and 3(b) are a side sectional view of the pump and a frontal view of the free end of the cartridge shaft, respectively, of a sprayer in accordance with an embodiment of the invention;

FIGS. 4(a) through 4(c) are perspective views in juxtaposition of the hopper and the transport frame and an enlarged exploded perspective view illustrating the interface of the hopper with a portion of the pump, respectively, of a sprayer in accordance with an embodiment of the invention; and

FIG. 5 is a perspective view of a removable control box engaged to the frame of a sprayer in accordance with an embodiment of the invention.

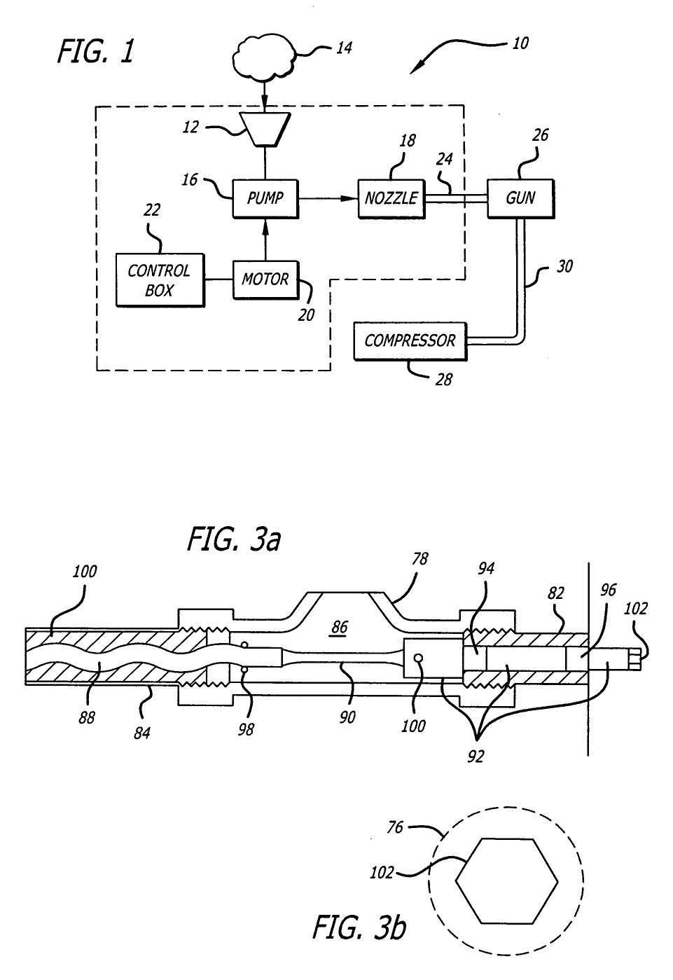

### DETAILED DESCRIPTION OF THE PREFERRED EMBODIMENT

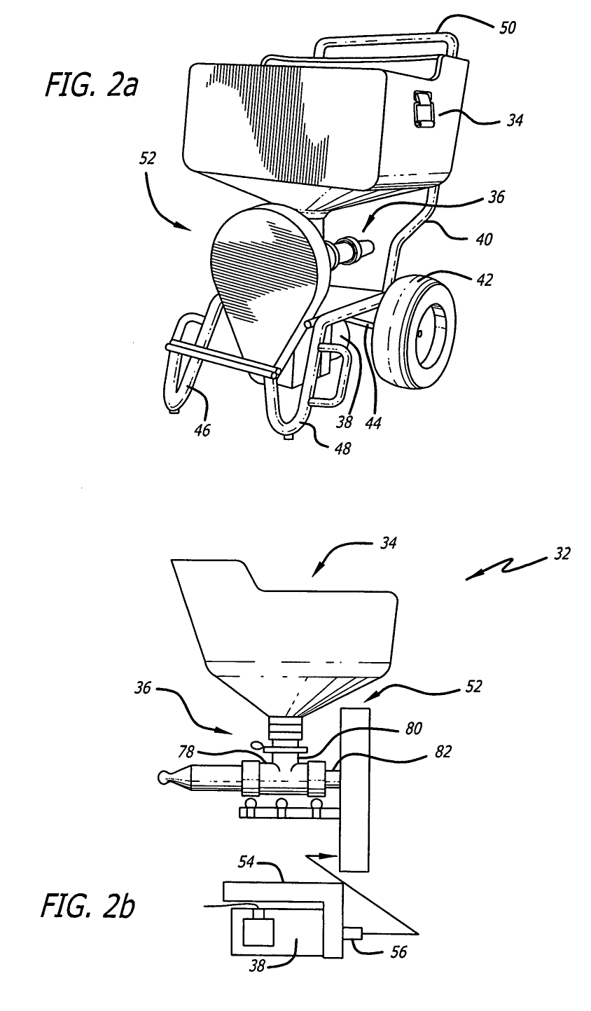

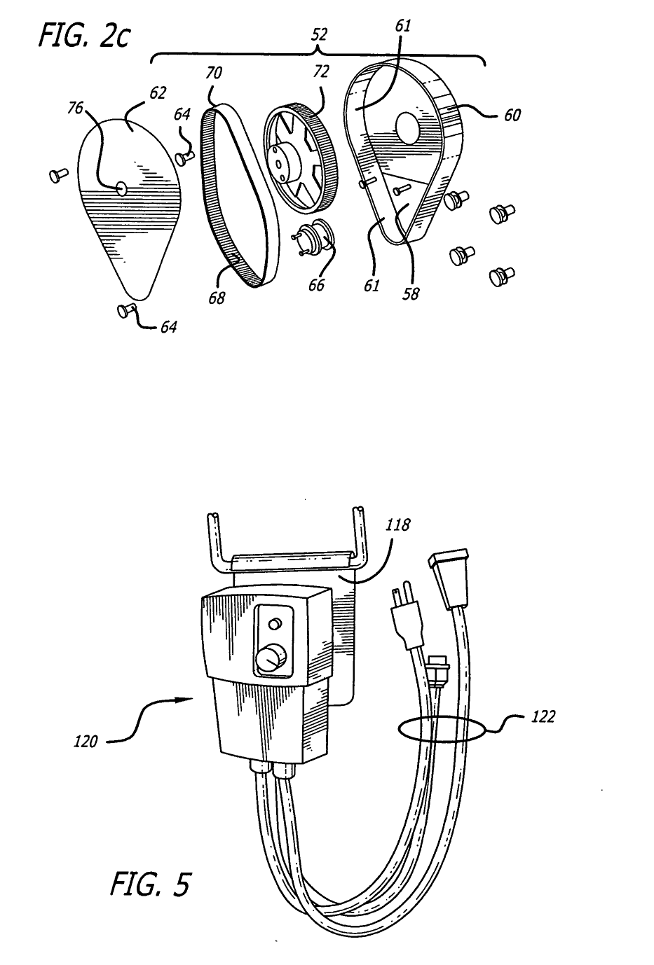

FIGS. 2(a) through 2(c) are a perspective view, a partially exploded side elevation view and an exploded perspective view of the cover assembly, respectively, of a sprayer in accordance with an embodiment of the invention. Such a sprayer includes numerous user-friendly features that facilitate maintenance, portability and usability. As a result, the device of the invention further advances the ability of a user to complete low volume texturizing jobs in an efficient manner and absent the “overkill” of large-scale systems.

As seen in FIG. 2(a), the sprayer 32 comprises two main functional units, a hopper 34 for receiving material and pump 36 whose operation is powered by an electric motor 38. (A control box for controlling the operation of the motor 38 cannot be seen in FIG. 2(a) but is described and illustrated below.) The entire sprayer assembly is mounted on a frame 40 that includes a pair of wheels 42 (only one of which is visible in FIG. 2(a)) that are aligned and rotatable about a common axis 44. The tubular frame 40 includes legs 46, 48 for stabilizing the sprayer 32 at rest and a handle for facilitating ready transport. As will be seen below, the hopper 34 is designed to facilitate transport of the sprayer 32 despite the presence of material within the hopper 34 while the design of the frame 40 facilitates the cooperative engagement of a removable control box, thereby permitting the sprayer 32 to be left outside during inclement weather that would otherwise subject the control electronics of the sprayer 32 to damage.

A guard 52 overlies the mechanism whereby the output of the motor 38 drives the pump 36. Such mechanism will be appreciated by additional reference to FIGS. 2(b), a partially-exploded side elevation view of the sprayer 32, and 2(c), an exploded perspective view of the guard 52 including associated mechanisms. Referring to FIGS. 2(a) through 2(c) now in combination, the motor 38 is fixed to a bracket mount 54 so that the output drive shaft 56 of the motor is arranged to protrude through a v-shaped opening 58 at the bottom of an inner cover 60 that includes a peripheral edge 61. A planar outer cover 62 is fixed to the inner cover by means of cap screws 64 whereby opposed planar surfaces of the inner and outer covers 60, 62 are maintained in parallel spacing defined by the height of the peripheral edge 61 of the inner cover 60.

A mentioned earlier, the drive shaft 56 of the motor 38 is aligned to protrude within the region formed between the inner and outer cover 60 and 62 at the v-shaped opening 58. A small gear is fixed to the end of the drive shaft 56 to engage a timing belt 68 for driving a large gear wheel 70. The large gear wheel 70 will be seen below to be fixed to an end of a drive train for driving the pump 36.

An annular hub 72 is located at the center of the large gear wheel 70 for coupling to a cartridge shaft (not shown) at the end of the drgive train of the pump. A upper aperture 74 within the rear cover 60 is aligned with both the center of the annular hub 72 and with an aperture 76 within the front cover 62. As a result, the end of the cartridge shaft is aligned with the aperture 76 when fixed to the annular hub 72. Accordingly, the end of the cartridge shaft is thereby accessible, through the aperture 76 of the front cover 62, without disassembly of the guard 52.

Reference is now made to FIGS. 2(b) and 3(a), a side sectional view of the pump 36 of a sprayer in accordance with an embodiment of the invention, in combination. As can be seen, the pump 36 includes a pump housing block 78 having an upstanding input port 80 for receiving gravity-fed material from the overlying hopper 34. A cartridge tube 82 and a stator 84 are treadably engaged to opposed ends of the pump housing block 78. The pump housing block 78 includes an internal elongated passageway 86 within which is located a pump drive train comprising, in combination, aligned elongated elements including a rotor , a connecting rod 90 and a cartridge shaft 92. The cartridge shaft 92 comprises and elongated member consisting of three adjoining cylindrical elements of successively reduced diameter (when one proceeds outwardly from the interior of the pump housing block 78). It is centered for rotation within the internal elongated passageway 86 of the pump housing block 78 by means of an inner bearing 94 and an outer bearing 96.

The connecting rod 90 is joined to the cartridge shaft 92 and to the rotor 88 by means of dowel pins 98, 100. The stator 84, of conventional design, includes a filled rubber interior 100 within, which the rotor 88 is aligned for rotation along the central axis of the elongated internal passageway 86 of the pump housing block 78. Accordingly, the axes of rotation of the elongated stator 88, the connecting rod 90 and the cartridge shaft 92 are aligned within the pump housing block 78.

The free end 102 of the cartridge shaft 92 is polygonal, preferably hexagonally shaped as seen in FIG. 3(b), a frontal view of the free end of the cartridge shaft 92. In the prior art, the rubber of the filled rubber interior 100 of the standard stator 88 is known to adhere to the rotor 88 during periods of non-use. As a consequence, disassembly of the pump 36 has been required to render the sprayer operational. Such disassembly can be tedious and time-consuming. To overcome this difficulty, in the present invention, the free end 102 of the cartridge shaft 92 comprises a polygonal shape that may be engaged by an appropriately-shaped socket wrench. Further, the cylinder shaft 92 is positioned in alignment with the aperture 76 within the outer cover 62 of the guard 52. As result, the free end 102 may be engaged by such a socket wrench without any disassembly. Once so engaged, the user can free the rotor from adhesion to the filled rubber interior 100 of the stator 84 by applying manual (or mechanical) for to the wrnch to cause the entire aligned, elongated pump drive assembly comprising the cylinder shaft 92, the connecting rod 90 and the rotor 88 to rotate a sufficient amount to break the adhesion force.

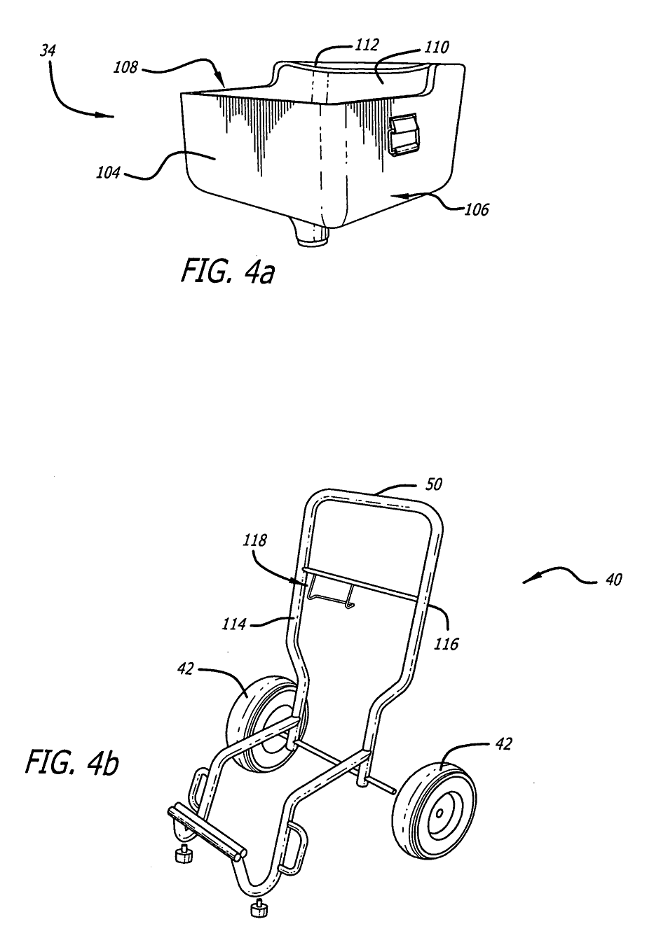

FIGS. 4(a) through 4(c) are perspective views in juxtaposition of the hopper and the transport frame of a sprayer in accordance with an embodiment of the invention. The hopper 34 comprises an integral molded structure of plastic or other synthetic composition that defines a volume within an interior bounded by a front panel 104, opposed side panels 106 and 108, and a rear panel 110. The height of the rear panel 110 exceeds that of the front panel 104. Accordingly, the edges of side panels 106 and 108 that intersect the rear panel 110 are of greater than those that intersect the front panel 104 as shown. A lid 112 protrudes from the top of the rear panel 110 and adjoins the extended regions of the side panels 106, 108 having heights approximately equal to that of the rear panel 110.

Viewing the hopper 34 in conjunction with the juxtaposed frame 40, one can see that the hopper 34 is aligned with respect to the transport frame so that the rear panel 110 lies against upstanding tubular frame members 114, 116 that define the back of the frame 40. Such members 114, 116 are positioned to rotate about the axle 44 common to the paired wheels 42. The permits the user to transport the sprayer by rotating the handle 50 downwardly and pushing the device. The lid 112 that covers the rear portion of the hopper 34 prevents the overflow of material from the hopper 34 during such transport. Thus, unlike other knockdown sprayers, one may relocate the sprayer of the invention without first emptying the hopper of drywall or other material prior to manual transport. This additionally simplifies and facilitates the use of the invention.

As can be seen in FIG. 4(b), a generally u-shaped flange member 118 is fixed to the handle 50 of the frame 40. Such member 118 is provided for engaging a mounting bracket 119 fixed to a control box 120 as illustrated in FIG. 5. The control box 120 provides the switches for adjusting the direction and speed of the electric motor 38 that, in turn, controls operation of the pump 36. While of standard design, it is significant that the control box 120 of a sprayer in accordance with an embodiment of the invention is fully removable, allowing its ready removal upon decoupling of associated cabling 122 from other elements of the sprayer. This permits one to then lift the control box 120 from the generally u-shaped flange 118 at the rear of the frame 40 for interior storage while the sturdy remainder of the sprayer is left outside. Again, this feature, a control box 120 removably fixed to the frame of the sprayer, further facilitates the use of the invention.

Thus it is seen that the present invention provides a user friendly sprayer of the knockdown type. By employing a sprayer in accordance with the claimed invention, the user enjoys numerous user-friendly features. Such features avoid any need to disassemble the sprayer pump after periods of prolonged non-use, permit manual transport of the sprayer while drywall or other material is present in the hopper and allow the device to be left outside during inclement weather.

While the invention has been described with reference to a presently-preferred embodiment, it is not limited thereto. Rather, the invention is limited only insofar as it is defined by the following set of patent claims and includes within its scope all equivalents thereof.

What is claimed is:

1. A sprayer for providing a regulated flow of material to a gun for subsequent dispersion onto a surface, said sprayer comprising, in combination:
a) a hopper for receiving said material;
b) a pump having an elongated cartridge shaft and an elongated augur aligned with said shaft and arranged to respond to rotation thereof;
c) said cartridge shaft having opposed coupled and free ends, said free end being of polygonal shape;
d) said pump being responsive to a motor;
e) a controller unit for controlling said motor;
f) said sprayer including a manually transportable frame.

2. A sprayer as defined in claim 1 further including:
a) a guard; and
b) said guard being arranged to extend over said free end of said cartridge shaft; and
c) said guard having an internal aperture in alignment with and exposing said free end of said cartridge shaft.

3. A sprayer as defined in claim 2 further including:
a) said motor having an output shaft;
b) a belt rotatably coupling said output shaft of said motor to said cartridge shaft; and
c) said guard being arranged to extend over said belt.

4. A sprayer as defined in claim 1 further including:
a) an elongated connecting rod having opposed ends; and
b) said opposed ends of said connecting rod being coupled to said augur and to said cartridge shaft.

5. A sprayer as defined in claim 4 wherein said augur, said connecting rod and said cartridge shaft are aligned within a pump housing.

6. A sprayer for providing a regulated flow of material to a gun for subsequent dispersion onto a surface, said sprayer comprising, in combination:
a) a hopper for receiving said material;
b) said hopper including (i) a bottom characterized by a plurality panels oriented to slope downwardly toward an internal aperture, (ii) substantially parallel side panels, a rear panel and a front panel extending upwardly from edges of said bottom to define a predetermined volume, (iii) the height of said rear panel exceeding that of said front panel and (iv) the heights of each of said side panels being equal to that of said rear panel at their junctions with said rear panel and being equal to that of said front panel at their junctions with said front panel;
c) a pump having an upstanding input port for receiving material from said hopper;
d) said pump being responsive to a motor;
e) a controller unit for controlling said motor;
f) said sprayer including a manually transportable frame.

7. A sprayer as defined in claim 6 further characterized in that said frame further includes:
a) a pair of wheels;
b) said wheels being aligned along a common axis of rotation; and
c) said common axis of rotation being oriented in substantial alignment with said rear panel of said hopper.

8. A sprayer as defined in claim 6 additionally including:
a) a substantially-planar lid; and
b) said lid being fixed to said rear panel of said hopper to overly a portion of said volume.

9. A sprayer for providing a regulated flow of material to a gun for subsequent dispersion onto a surface, said sprayer comprising, in combination:
a) a hopper for receiving said material;
b) a pump having an upstanding input port for receiving material from said hopper;
c) said pump being responsive to a motor;
d) a control box for controlling said motor;
e) said sprayer including a manually transportable frame;
f) said frame including at least one horizontal rear frame member;
g) a generally u-shaped flange member being fixed to said horizontal rear frame member; and
h) said control box having a hook for engaging said u-shaped member.

10. A sprayer as defined in claim 9 wherein said hook comprises an elongated mounting bracket having a length substantially equal to the width of said control box.

11. A sprayer as defined in claim 10 wherein said mounting bracket is fixed to the top of said control box.
